(19) United States
(12) Patent Application Publication
(10) Pub. No.: US 2018/0196992 A1
(43) Pub. Date: Jul. 12, 2018

(54) METHOD AND ELECTRONIC DEVICE FOR RECOGNIZING A FINGER

(71) Applicant: Egis Technology Inc., Taipei (TW)

(72) Inventors: Po-Yen Chen, Taipei (TW); Yuan-Lin Chiang, Taipei (TW)

(21) Appl. No.: 15/809,959

(22) Filed: Nov. 10, 2017

Related U.S. Application Data
(60) Provisional application No. 62/444,959, filed on Jan. 11, 2017.

(30) Foreign Application Priority Data
Aug. 1, 2017 (CN) 201710647877.3

(51) Int. Cl. G06K 9/00

(52) U.S. Cl. CPC G06K 9/00114; G06K 9/00067

(57) ABSTRACT

A method for recognizing a finger, including: sensing a recognized object which is placed on a fingerprint sensing device to generate a first frame; selecting at least one block from the frame, wherein each of the blocks comprises a plurality of block groups; computing a sequence of characteristic values of each of the block groups according to a plurality of Haar-like features; and respectively substituting the sequences of characteristic values of the block groups into a polynomial to determine whether the recognized object is a finger.

### CROSS REFERENCE TO RELATED APPLICATIONS

This application claims priority of Provisional Patent Application No. 62/444,959 filed on Jan. 11, 2017, and CN Patent Application No. 201710647877.3 filed on Aug. 1, 2017, the entirety of which is incorporated by reference herein.

### BACKGROUND OF THE INVENTION

### Field of the Invention

The invention generally relates to technology for recognizing a finger, and more particularly, to technology for recognizing a finger and a non-finger object according to Haar-like features.

### Description of the Related Art

Electronic devices that have the function of fingerprint recognition are popular on the market. Before performing fingerprint recognition, in order to prevent a false trigger by a non-finger object, the electronic device may determine whether the object placed on the fingerprint sensing device is a finger. In the conventional method for determining whether the object placed on the fingerprint sensing device is a finger, the electronic device determines whether the object placed on the fingerprint sensing device is a finger according to the number of shade variations of the lines in the image. When the number of shade variations of the lines is great, it means that the textures of the object are full of variety, and the electronic device may therefore determine that the object is a finger. However, when the method is applied to a water droplet or a wet finger, errors in judgment may easily occur.

### BRIEF SUMMARY OF THE INVENTION

A method and electronic device for recognizing a finger and a non-finger object according to Haar-like features are provided.

An embodiment of the invention provides a method for recognizing a finger. The method is applied to an electronic device which comprises a fingerprint sensing device. The method comprises the steps of sensing a recognized object placed on the fingerprint sensing device to generate a frame; selecting at least one block from the frame, wherein each of the blocks comprises a plurality of block groups; calculating a sequence of characteristic values corresponding to each of the block groups according to a plurality of Haar-like features; and respectively substituting the sequence of characteristic values corresponding to each of the block groups into a polynomial to determine whether the recognized object placed on the fingerprint sensing device is a finger.

An embodiment of the invention provides an electronic device. The electronic device comprises a fingerprint sensing device and a processor. The fingerprint sensing device senses a recognized object placed on the fingerprint sensing device to generate a frame. The processor is coupled to the fingerprint sensing device. The processor selects at least one block from the frame, wherein each of the blocks comprises a plurality of block groups, calculates a sequence of characteristic values corresponding to each of the block groups according to a plurality of Haar-like features, and substitutes the sequence of characteristic values corresponding to each of the block groups into a polynomial respectively to determine whether the recognized object placed on the fingerprint sensing device is a finger.

Other aspects and features of the invention will become apparent to those with ordinary skill in the art upon review of the following descriptions of specific embodiments of methods and devices.

### BRIEF DESCRIPTION OF THE DRAWINGS

The invention will become more fully understood by referring to the following detailed description with reference to the accompanying drawings, wherein:

FIG. 1 is a block diagram of an electronic device 100 according to an embodiment of the invention;

FIG. 2 is a schematic diagram illustrating the fingerprint sensing device 110 according to an embodiment of the invention;

FIG. 3A is a schematic diagram illustrating the frame F according to an embodiment of the invention;

FIG. 3B is a schematic diagram illustrating the block B1 according to an embodiment of the invention.

FIG. 4 is a schematic diagram illustrating a plurality of Haar-like features according to an embodiment of the invention; and

FIGS. 5A-5B is a flow chart 500 illustrating a method for recognizing a finger according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

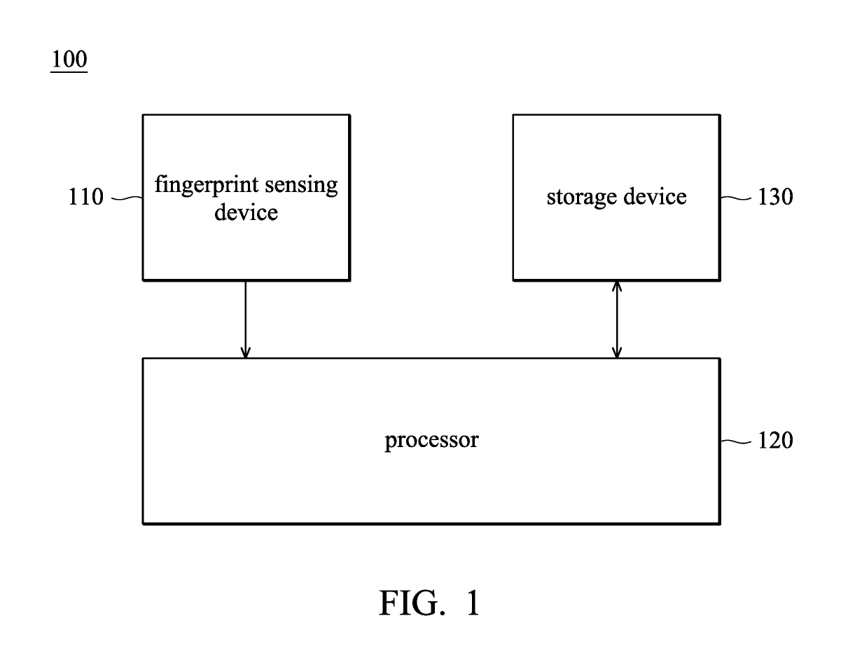

FIG. 1 is a block diagram of an electronic device 100 according to an embodiment of the invention. In an embodiment of the invention, the electronic device 100 is an electronic device with a fingerprint recognition function, e.g. a mobile phone, a smartphone, a tablet computer, a note book, and so on. As shown in FIG. 1, the electronic device 100 comprises a fingerprint sensing device 110, a processing unit 120 and a storage device 130. FIG. 1 presents a simplified block diagram in which only the elements relevant to the invention are shown. However, the invention should not be limited to what is shown in FIG. 1.

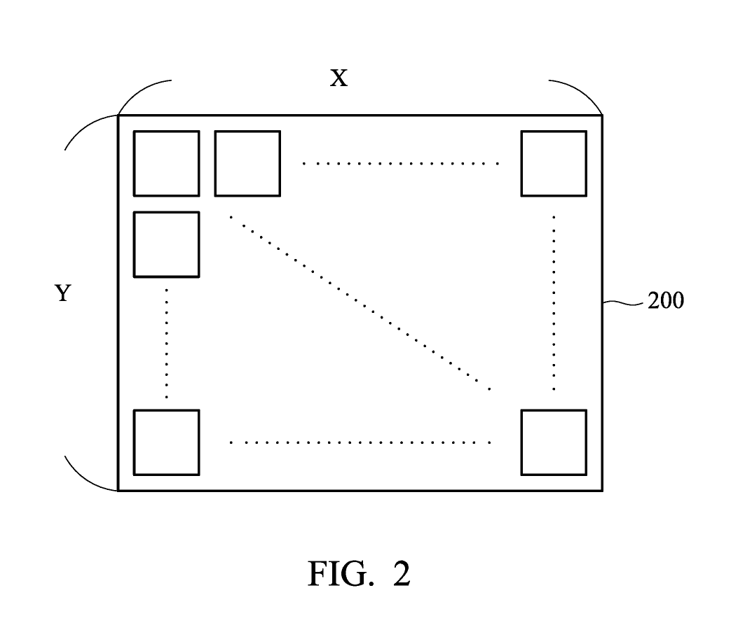

In the embodiments of the invention, the fingerprint sensing device 110 may be a sensing chip, but the invention should not be limited thereto. The fingerprint sensing device 110 may comprise a sensing array, and the sensing array comprises a plurality of sensing units arranged in two dimensions and each of the sensing units corresponds to a pixel. FIG. 2 is a schematic diagram illustrating the fingerprint sensing device 110 according to an embodiment of the invention. As shown in FIG. 2, the fingerprint sensing device 110 comprises a sensing array 200, and the sensing array 200 comprises X×Y sensing units. In an embodiment of the invention, the storage device 130 may store the data generated by the fingerprint sensing device 110 and store the Haar-like features and a polynomial P.

According to the embodiments of the invention, a polynomial P and a first threshold are stored in the storage device 130 in advance. The Haar-like features are image features used for object recognition, and they comprise a plurality of types of image features. According to the embodiments of the invention, some common and representative types of Haar-like features (e.g. 6 types of Haar-like features) may be selected in advance, and the selected Haar-like features may be stored in the storage device 130. The polynomial P is expressed as:

P=f₀w₀+f₁w₁+f₂w₂+f₃w₃+f₄w₄+f₅w₅,

wherein w₀, w₁, w₂, w₃, w₄ and w₅ are constants, and they are calculated and obtained through the Support Vector Machine (SVM) and respectively represent the weights of the 6 selected types of Haar-like features; and f₀, f₁, f₂, f₃, f₄ and f₅ are variables and respectively represent the characteristic values corresponding to the 6 selected types of Haar-like features.

According to the embodiments of the invention, in order to generate the polynomial P, the weights w₀, w₁, w₂, w₃, w₄ and w₅ and the first threshold, the data of a representative fingerprint database (e.g. 50 thousand block groups of fingerprint, wherein each of the block groups comprises 6×6 pixels) and the data of a representative water-stain database (e.g. 50 thousand block groups of water stain, wherein each of the block groups comprises 6×6 pixels) may respectively be input into the Support Vector Machine (SVM). Specifically, the 50 thousand sequences of characteristic values [f₀, f₁, f₂, f₃, f₄, f₅] corresponding to the 50 thousand block groups of fingerprint and the 50 thousand sequences of characteristic values [f₀, f₁, f₂, f₃, f₄, f₅] corresponding to the 50 thousand block groups of water-stain will be substituted into the polynomial P to calculate and obtain the weights w₀, w₁, w₂, w₃, w₄ and w₅ respectively corresponding to the 6 selected types of Haar-like features and calculate and obtain the first threshold through a machine learning method (e.g. SVM algorithm). The method for generating the sequence of characteristic values [f₀, f₁, f₂, f₃, f₄, f₅] corresponding to each of the block groups will be illustrated below. It should be noted that the form of the polynomial P is not limited to the polynomial shown above. The polynomial P may be different according to the different numbers of selected types of Haar-like features.

According to the embodiments of the invention, when the fingerprint sensing device 110 senses an object placed on the fingerprint sensing device 110, the fingerprint sensing device 110 may sense the object and generate a frame F corresponding to the object. The frame F has X×Y pixels.

In an embodiment of the invention, after the processor 120 obtains the frame F, the processor 120 may select at least one block B from the frame F.

Each of the blocks B may comprise a plurality of sub-blocks Sub-B, and each of the sub-blocks Sub-B is one pixel. Each of the blocks B may be an M×M pixel matrix, wherein M is an even number, and M≥4. That is to say, each of the blocks B may comprise M×M sub-blocks Sub-B. In addition, the processor 120 may divide the M×M sub-blocks Sub-B into a plurality of block groups GB. Each of the block groups GB may be an N×N pixel matrix, i.e. each of the block groups GB may comprise N×N sub-blocks Sub-B, wherein N=M/2 or M/3. For example, if a block B comprises 4×4 sub-blocks Sub-B, the block B may comprise 4 block groups GB which respectively comprise 2×2 sub-blocks Sub-B. If a block B comprises 18×18 sub-blocks Sub-B, the block B may comprise 9 block groups GB which respectively comprise 6×6 sub-blocks Sub-B.

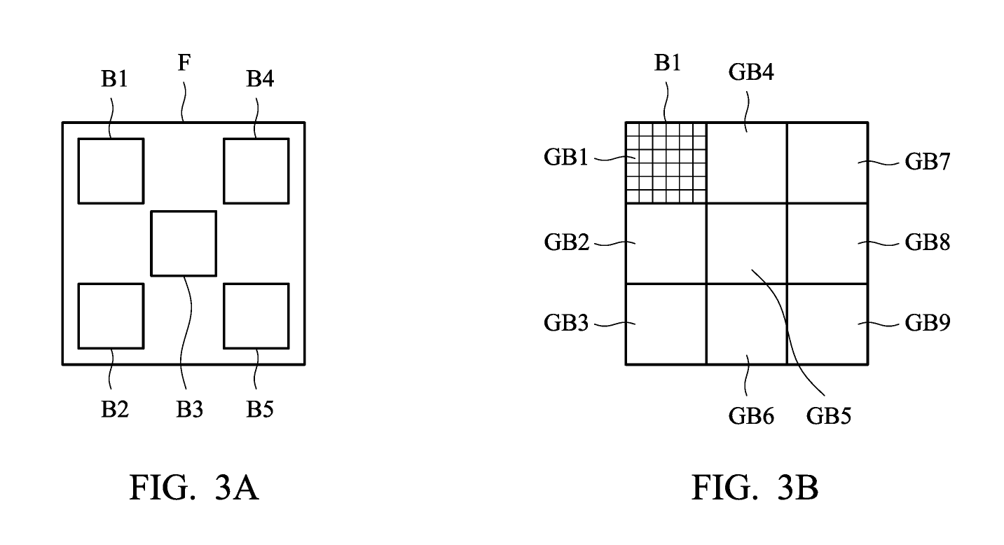

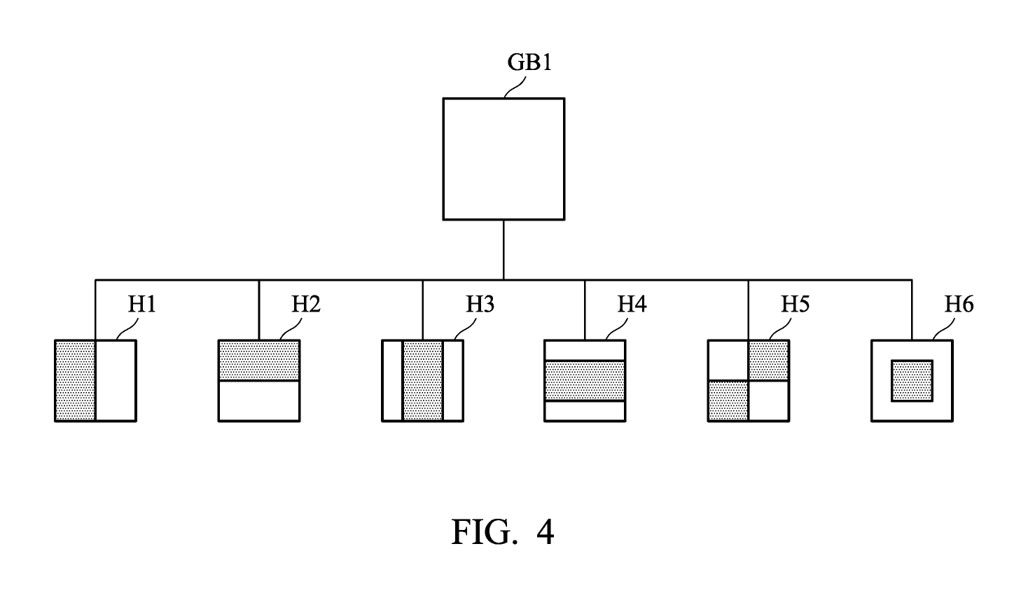

FIG. 3A is a schematic diagram illustrating the frame F according to an embodiment of the invention. As shown in FIG. 3A, the processor 120 selects blocks B1˜B5, wherein each of the blocks B1˜B5 comprises 18×18 sub-blocks (as shown in FIG. 2B). FIG. 3B is a schematic diagram illustrating the block B1 according to an embodiment of the invention. As shown in FIG. 3B, the processor 120 may divide the 18×18 sub-blocks of the block B1 into 9 groups of 6×6 sub-blocks. Therefore, the block B1 may comprise 9 groups of 6×6 sub-blocks, i.e. block groups GB1, GB2, GB3 . . . GB9. It should be noted that the schematic diagrams of FIGS. 3A and 3B are utilized only to illustrate the embodiments of the invention. However, the invention should not be limited thereto. In other embodiments of the invention, a different number of blocks may be selected from the frame F, and the distribution of the blocks in frame F may be different from that shown in FIGS. 3A and 3B (e.g. non-symmetric distribution or random distribution). Furthermore, in other embodiments of the invention, the blocks in the frame F may comprise a different number of sub-blocks and block groups.

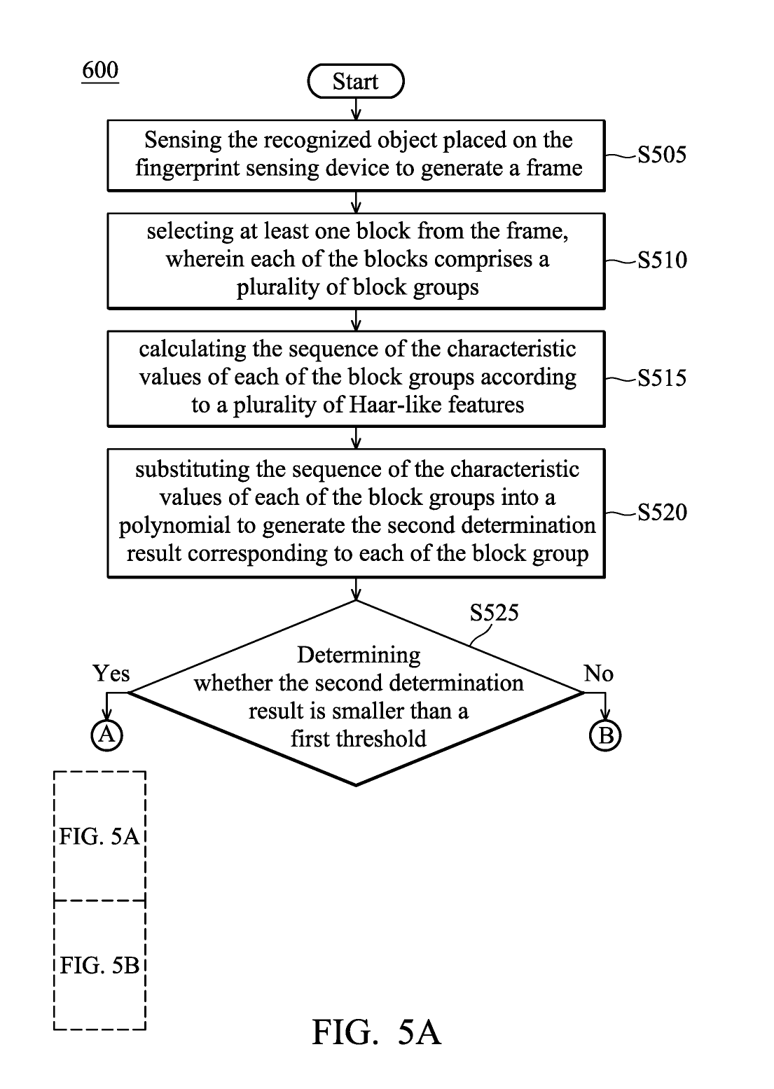

According to the embodiments of the invention, the processor 120 may calculate the sequence of characteristic values of each of the block groups GB according to a plurality of Haar-like features. The Haar-like features are image features used for object recognition, and they comprise a plurality of types of image features. For example, the types of Haar-like features may comprise types of edge features (e.g. Haar-like features H1 and H2 shown in FIG. 4), types of line features (e.g. Haar-like features H3, H4 and H5 shown in FIG. 4), and types of point features (e.g. Haar-like feature H6 shown in FIG. 4), but the invention should not be limited thereto. As per the above description, in the embodiments of the invention, some common and representative types of Haar-like features (e.g. 6 types of Haar-like features) may be selected from Haar-like features to be the basis of calculating the sequence of characteristic values corresponding to each of the block groups. FIG. 4 is used for illustration below.

FIG. 4 is a schematic diagram illustrating a plurality of Haar-like features according to an embodiment of the invention. As shown in FIG. 4, FIG. 4 shows 6 types of Haar-like features, H1, H2, H3, H4, H5 and H6. It should be noted that the schematic diagram of FIG. 4 is utilized only to illustrate the embodiments of the invention. However, the invention should not be limited thereto. The processor 120 also can select other types of Haar-like features and also can select a different number of Haar-like features.

Referring to FIG. 4, the processor 120 may calculate the sequence of characteristic values [f₀, f₁, f₂, f₃, f₄, f₅] of the block group GB1 according to the Haar-like features shown in FIG. 4, wherein the characteristic values f₀, f₁, f₂, f₃, f₄ and f₅ respectively correspond to Haar-like features H1, H2, H3, H4, H5 and H6, and each of the block groups has its corresponding sequence of characteristic values [f₀, f₁, f₂, f₃, f₄, f₅]. When calculating the characteristic value corresponding to one Haar-like feature, the processor 120 may subtract the sum of the gray-level values of all sub-blocks (i.e. all pixels) corresponding to the white part of the Haar-like feature from the sum of the gray-level values of all sub-blocks (i.e. all pixels) corresponding to the black part of the Haar-like feature in the block group GB1 to obtain the characteristic value corresponding to the Haar-like feature of the block group GB1. For example, when the processor 120 calculates the characteristic value f₀ of the block group GB1, the processor 120 may subtract the sum of the gray-level values of all sub-blocks (i.e. all pixels) corresponding to the white part of the Haar-like feature H1 (i.e. the sum of the gray-level values of all sub-blocks (i.e. all pixels) in the right part of the block group GB1) from the sum of the gray-level values of all sub-blocks (i.e. all pixels) corresponding to the black part of the Haar-like feature H1 (i.e. the sum of the gray-level values of all sub-blocks (i.e. all pixels) in the left part of the block group GB1) to obtain the characteristic value f₀ corresponding to Haar-like feature H1 of the block group GB1. Accordingly, as the method of obtaining the sequence of characteristic values [f₀, f₁, f₂, f₃, f₄, f₅] of block group GB1, the processor 120 may calculate the sequences of characteristic values [f₀, f₁, f₂, f₃, f₄, f₅] of block groups GB2, GB3, GB4, GB5 . . . and GB9 according to the Haar-like features shown in FIG. 4.

In the embodiment of the invention, when the processor 120 determines whether the recognized object placed on the fingerprint sensing device is a finger, the processor may obtain a first determination result of each of the blocks B of the recognized object. In order to obtain the first determination result, the processor 120 may calculate a second determination result corresponding to each of the block groups GB of the block B first. In order to obtain the second determination result, after the processor 120 calculates the sequence of characteristic values [f₀, f₁, f₂, f₃, f₄, f₅] of the block group GB, the processor 120 will substitute the sequence of characteristic values [f₀, f₁, f₂, f₃, f₄, f₅] into the polynomial P to generate the second determination result corresponding to the block group GB. Accordingly, the processor 120 may substitute the sequence of characteristic values [f₀, f₁, f₂, f₃, f₄, f₅] corresponding to each of the block groups GB into the polynomial P to generate the second determination result corresponding to the block group GB to determine whether the block group GB corresponds to a finger. The details are illustrated below.

In an embodiment of the invention, the processor 120 may determine whether the second determination result corresponding to a block group GB is smaller than the first threshold. When the second determination result is smaller than the first threshold, the processor 120 may determine that the block group GB corresponding to the second determination result corresponds to a finger. When the second determination result is greater than or equal to the first threshold, the processor 120 may determine that the block group GB corresponding to the second determination result corresponds to a non-finger object. For example, if the first threshold is 1000, when the determination result corresponding to the block group GB is 500, the processor 120 may determine that the block group GB corresponds to a finger. If the first threshold is 1000, when the determination result corresponding to the block group GB is 1200, the processor 120 may determine that the block group GB corresponds to a non-finger object.

In an embodiment of the invention, when in a block B, the number of block groups GB which are determined to correspond to a finger is greater than or equal to a second threshold, the processor 120 may determine that the block B corresponds to the finger. When in the block B, the number of block groups GB which are determined to correspond to a finger is smaller than the second threshold, the processor 120 may determine that the block B corresponds to a non-finger object. Taking FIG. 3B for example, if the second threshold is 6 and out of the 9 block groups (each of the block groups comprises 6×6 pixels) of block B1, 6 or more block groups GB are determined to correspond to a finger, the processor 120 may determine that the block B1 corresponds to the finger.

In another embodiment of the invention, when in a block B, the number of block groups GB which are determined to correspond to a finger is greater than or equal to the number of block groups GB which are determined to correspond to a non-finger object, the processor 120 may determine that the block B corresponds to the finger. When in a block B, the number of block groups GB which are determined to correspond to a finger is smaller than the number of block groups GB which are determined to correspond to a non-finger object, the processor 120 may determine that the block B corresponds to a non-finger object.

In an embodiment of the invention, when in a frame F, the number of blocks B which are determined to correspond to a finger (i.e. the first determination result) is greater than or equal to a third threshold, the processor 120 may determine that the recognized object placed on the fingerprint sensing device 110 is a finger. When in a frame F, the number of blocks B which are determined to correspond to a finger (i.e. the first determination result) is smaller than a third threshold, the processor 120 may determine that the recognized object placed on the fingerprint sensing device 110 is a non-finger object. Taking FIG. 3A for example, if the third threshold is 3 and out of the blocks B1˜B5 of the frame F, 3 or more blocks are determined to correspond to a finger, the processor 120 may determine that the recognized object placed on the fingerprint sensing device 110 is a finger.

In another embodiment of the invention, when the first determination result (i.e. the number of the blocks B which are determined to correspond to a finger in the frame F) is greater than or equal to the number of the blocks B which are determined to correspond to a non-finger object in the frame F, the processor 120 may determine that the recognized object placed on the fingerprint sensing device 110 is a finger. When the first determination result (i.e. the number of the blocks B which are determined to correspond to a finger in the frame F) is smaller than the number of blocks B which are determined to correspond to a non-finger object in the frame F, the processor 120 may determine that the recognized object placed on the fingerprint sensing device 110 is a non-finger.

In another embodiment of the invention, when all of the blocks B in a half (e.g. left half, right half, upper half or lower half) of the frame F are determined to correspond to a finger, the processor 120 may determine that the recognized object placed on the fingerprint sensing device 110 is a finger. For example, when all of the blocks B in the left half of the frame F are determined to correspond to a finger, the processor 120 may determine that the recognized object placed on the fingerprint sensing device 110 is a finger.

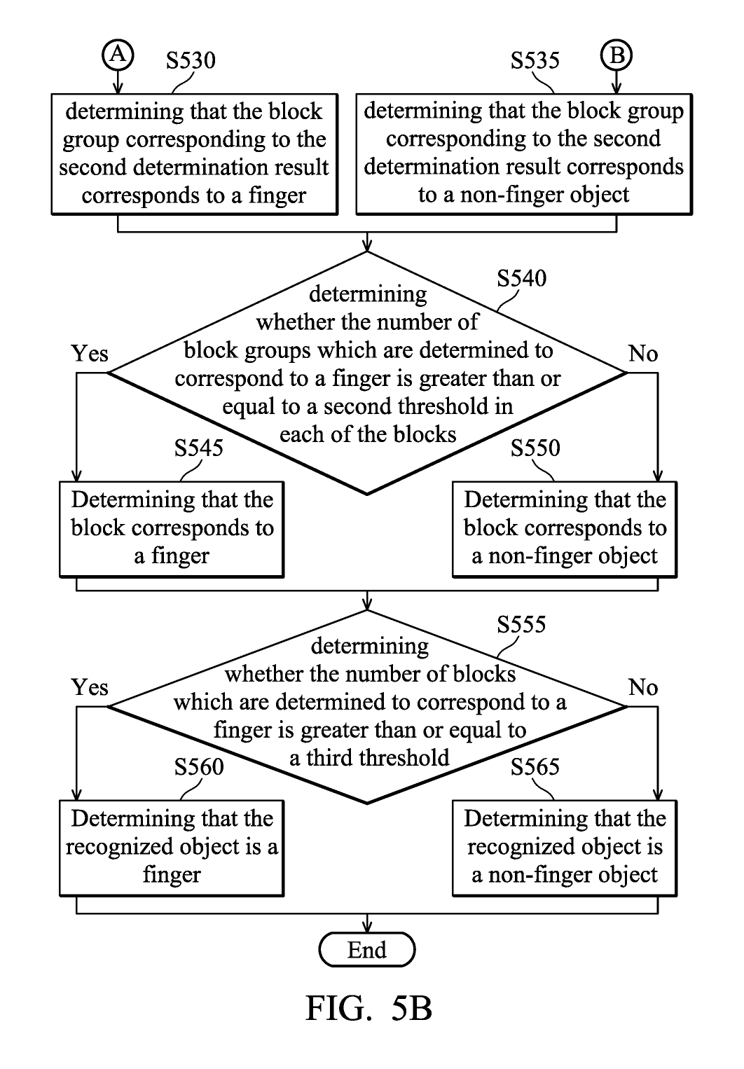

FIGS. 5A-5B show a flow chart 500 illustrating a method for recognizing a finger according to an embodiment of the invention. The method for recognizing a finger is applied to the electronic device 100. As shown in FIGS. 5A-5B, in step S505, the electronic device 100 senses the recognized object placed on the fingerprint sensing device 110 via the fingerprint sensing device 110 to generate a frame. In step S510, the electronic device 110 selects at least one block from the frame, wherein each of the blocks comprises a plurality of block groups. In step S515, the electronic device 100 calculates the sequence of the characteristic values of each of the block groups according to a plurality of Haar-like features. In step S520, the electronic device 100 substitutes the sequence of the characteristic values of each of the block groups into a polynomial to generate a second determination result corresponding to each of the block groups.

In step S525, the electronic device 100 determines whether the second determination result is smaller than a first threshold. When the second determination result is smaller than the first threshold, step S530 is performed. In step S530, the electronic device 100 determines that the block group corresponding to the second determination result corresponds to a finger. When the second determination result is greater than or equal to the first threshold, step S535 is performed. In step S535, the electronic device 100 determines that the block group corresponding to the second determination result corresponds to a non-finger object.

In step S540, the electronic device 100 determines whether the number of block groups which are determined to correspond to a finger is greater than or equal to a second threshold in each of the blocks. When the number of block groups which are determined to correspond to a finger is greater than or equal to the second threshold, step S545 is performed. In step S545, the electronic device 100 determines that the block corresponds to a finger. When the number of block groups which are determined to correspond to a finger is smaller than the second threshold, step S550 is performed. In step S550, the electronic device 100 determines that the block corresponds to a non-finger object.

In another embodiment of the invention, in step S540, the electronic device 100 determines whether the number of block groups which are determined to correspond to a finger is greater than or equal to the number of block groups which are determined to correspond to a non-finger object in each of the blocks. When the number of block groups which are determined to correspond to a finger is greater than or equal to the number of block groups which are determined to correspond to a non-finger object, the electronic device 100 may determine that the block corresponds to a finger. When the number of block groups which are determined to correspond to a finger is smaller than the number of block groups which are determined to correspond to a non-finger object, the electronic device 100 may determine that the block corresponds to a non-finger object.

In step S555, the electronic device 100 determines whether the number of blocks which are determined to correspond to a finger (referred to as a first determination result below) is greater than or equal to a third threshold. When the first determination result is greater than or equal to the third threshold, step S560 is performed. In step S560, the electronic device 100 determines that the recognized object is a finger. When the first determination result is smaller than the third threshold, step S565 is performed. In step S565, the electronic device 100 determines that the recognized object is a non-finger object.

In another embodiment of the invention, in step S555, the electronic device 100 determines whether the number of blocks which are determined to correspond to a finger (referred to as a first determination result below) is greater than or equal to the number of blocks which are determined to correspond to a non-finger object. When the number of blocks which are determined to correspond to a finger is greater than or equal to the number of blocks which are determined to correspond to a non-finger object, the electronic device 100 determines that the recognized object is a finger. When the number of blocks which are determined to correspond to a finger is smaller than the number of blocks which are determined to correspond to a non-finger object, the electronic device 100 determines that the recognized object is a non-finger object.

In another embodiment of the invention, in step S555, the electronic device 100 determines whether the blocks in a half of the frame are all determined to correspond to a finger. When the blocks in a half of the frame are all determined to correspond to a finger, the electronic device 100 may determine that the recognized object is a finger (S560). Otherwise, the electronic device 100 may determine that the recognized object is a non-finger object (S565).

The method and electronic device for recognizing a finger provided in the embodiments of the invention can prevent the false trigger caused by a non-finger object when the non-finger object (e.g. water droplet) is placed on the fingerprint sensing device 110. The method and electronic device for recognizing a finger provided in the embodiments of the invention also can prevent the error judgment occurring when a wet finger is placed on the fingerprint sensing device 110. Therefore, the method and electronic device for recognizing a finger provided in the embodiments of the invention can increase the accuracy for recognizing a finger and a non-finger object.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. Alternatively, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

Reference throughout this specification to “one embodiment” or “an embodiment” means that a particular feature, structure, or characteristic described in connection with the embodiment is included in at least one embodiment of the invention, but do not denote that they are present in every embodiment. Thus, the appearances of the phrases “in one embodiment” or “in an embodiment” in various places throughout this specification are not necessarily referring to the same embodiment of the invention.

The above paragraphs describe many aspects. Obviously, the teaching of the invention can be accomplished by many methods, and any specific configurations or functions in the disclosed embodiments only present a representative condition. Those who are skilled in this technology will understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A method for recognizing a fingerprint, applied to an electronic device which comprises a fingerprint sensing device, the method comprising:
sensing a recognized object placed on the fingerprint sensing device to generate a frame;
selecting at least one block from the frame, wherein each of the blocks comprises a plurality of block groups;
calculating a sequence of characteristic values corresponding to each of the block groups according to a plurality of Haar-like features; and
respectively substituting the sequence of characteristic values corresponding to each of the block groups into a polynomial to determine whether the recognized object placed on the fingerprint sensing device is a finger.

2. The method of claim 1, further comprising:
generating the polynomial and a first threshold according to the plurality of Haar-like features and a Support Vector Machine (SVM) algorithm.

3. The method of claim 2, further comprising:
respectively substituting the sequence of characteristic values corresponding to each of the block groups into the polynomial to generate a determination result corresponding to each of the block groups.

4. The method of claim 3, further comprising:
determining that the block group corresponding to the determination result corresponds to a finger when the determination result is smaller than the first threshold; and
determining that the block group corresponding to the determination result corresponds to a non-finger object when the determination result is greater than or equal to the first threshold.

5. The method of claim 4, further comprising:
determining that the block corresponds to a finger when the number of block groups which correspond to a finger is greater than or equal to a second threshold in the block; and
determining that the block corresponds to a non-finger object when the number of block groups which correspond to a finger is smaller than the second threshold in the block.

6. The method of claim 4, further comprising:
determining that the block corresponds to a finger when the number of block groups which correspond to a finger is greater than or equal to the number of block groups which correspond to a non-finger object in the block; and
determining that the block corresponds to a non-finger object when the number of block groups which correspond to a finger is smaller than the number of block groups which correspond to a non-finger object in the block.

7. The method of claim 1, further comprising:
determining that the recognized object corresponds to a finger when the number of blocks which correspond to a finger is greater than or equal to a third threshold in the frame; and
determining that the recognized object corresponds to a non-finger object when the number of block groups which correspond to a finger is smaller than the third threshold in the frame.

8. The method of claim 1, further comprising:
determining that the recognized object corresponds to a finger when the number of blocks which correspond to a finger is greater than or equal to the number of blocks which correspond to a non-finger object in the frame; and
determining that the recognized object corresponds to a non-finger object when the number of block groups which correspond to a finger is smaller than the number of block groups which correspond to a non-finger object in the frame.

9. The method of claim 1, further comprising:
determining that the recognized object corresponds to a finger when the blocks in a half of the frame correspond to a finger.

10. An electronic device, comprising:
a fingerprint sensing device, sensing a recognized object placed on the fingerprint sensing device to generate a frame; and
a processor, coupled to the fingerprint sensing device, wherein the processor selects at least one block from the frame, wherein each of the blocks comprises a plurality of block groups, calculates a sequence of characteristic values corresponding to each of the block groups according to a plurality of Haar-like features, and respectively substitutes the sequence of characteristic values corresponding to each of the block groups into a polynomial to determine whether the recognized object placed on the fingerprint sensing device is a finger.

11. The electronic device of claim 10, wherein the processor generates the polynomial and a first threshold according to the plurality of Haar-like features and a Support Vector Machine (SVM) algorithm.

12. The electronic device of claim 11, wherein the processor further substitutes the sequence of characteristic values corresponding to each of the block groups into the polynomial respectively to generate a determination result corresponding to each of the block groups.

13. The electronic device of claim 12, wherein when the determination result is smaller than the first threshold, the processor determines that the block group corresponding to the determination result corresponds to a finger; and when the determination result is greater than or equal to the first threshold, the processor determines that the block group corresponding to the determination result corresponds to a non-finger object.

14. The electronic device of claim 13, wherein when the number of block groups which correspond to a finger is greater than or equal to a second threshold in the block, the processor determines that the block corresponds to a finger; and when the number of block groups which correspond to a finger is smaller than the second threshold in the block, the processor determines that the block corresponds to a non-finger object.

15. The electronic device of claim 13, wherein when the number of block groups which correspond to a finger is greater than or equal to the number of block groups which correspond to a non-finger object in the block, the processor determines that the block corresponds to a finger; and when the number of block groups which correspond to a finger is smaller than the number of block groups which correspond to a non-finger object in the block, the processor determines that the block corresponds to a non-finger object.

16. The electronic device of claim 10, wherein when the number of blocks which correspond to a finger is greater than or equal to a third threshold in the frame, the processor determines that the recognized object corresponds to a finger; and when the number of blocks which correspond to a finger is smaller than the third threshold in the frame, the processor determines that the recognized object corresponds to a non-finger object.

17. The electronic device of claim 10, wherein when the number of blocks which correspond to a finger is greater than or equal to the number of blocks which correspond to a non-finger object in the frame, the processor determines that the recognized object corresponds to a finger; and when the number of blocks which correspond to a finger is smaller than the number of blocks which correspond to a non-finger object in the frame, the processor determines that the recognized object corresponds to a non-finger object.

18. The electronic device of claim 10, wherein when the blocks in a half of the frame correspond to a finger, the processor determines that the recognized object corresponds to a finger.
